(19) United States
(12) Patent Application Publication
(10) Pub. No.: US 2009/0149059 A1
(43) Pub. Date: Jun. 11, 2009

(54) Electric Wire Coupler

(76) Inventor: Guy Meir Refael, Kiryat Ono (IL)

Correspondence Address: THE NATH LAW GROUP, 112 South West Street, Alexandria, VA, 22314, US

(21) Appl. No.: 11/992,471

(22) PCT Filed: Sep. 21, 2006
(86) PCT No.: PCT/IL2006/001107

§ 371 Date: Apr. 8, 2008

(30) Foreign Application Priority Data
Sep. 22, 2005 (IL) 171041

(51) Int. Cl. H01R 4/26; H01R 11/00

(52) U.S. Cl. 439/394; 439/406

(57) ABSTRACT

An electrical wire coupler adapted to electrically connect at least two wires, each comprising a conductive core and insulation therearound, is provided. The coupler comprises at least two compartments independently openable. Each of the compartments allows, in an open position, placement therein of at least one wire and, in a closed position, retention therein of the at least one wire. The coupler further comprises conductive portions adapted to contact the conductive core, wherein each compartment comprises at least one of the conductive portions, and at least some of the conductive portions are electrically connected to other portions.

### FIELD OF THE INVENTION

This invention relates to the coupling of insulated electrical wires.

### BACKGROUND OF THE INVENTION

Insulated wire cables coupling devices are well known and widely used. Examples of such devices are disclosed, for example in U.S. Pat. No. 4,274,198 and U.S. Pat. No. 4,291,935.

Most of known devices are adapted to couple a pair of insulated wire cables and they include electrically connected conductive connectors each adapted to contact the conductive core of one of the cables. These devices may operate with and without pre-stripping of the insulating coating of the wire cable. In the former case, the connectors may be designed for stripping the insulating coating, e.g. for example may be in the form of a pair of blades facing each other to define therebetween a slot for pressure insertion a cable therein. Such a connector is disclosed, for example, in U.S. Pat. No. 6,165,003.

Some of known devices further include cable receiving channels to accommodate the insulated wire cables, and one or more obstruction elements for the restriction of the cables' spatial displacement in the channels. The devices may have compartments movable one relative to the other, to close the device by virtue of which both cable receiving channels are formed with the cables mounted therein, and the stripping and, consequently, the connection is performed. In some devices, measures are taken to restrict movement of the cables in their radial direction.

### SUMMARY OF THE INVENTION

According to one aspect of the present invention, there is provided an electrical wire coupler adapted to electrically connect at least two wires. The wires each comprise a conductive core and insulation therearound. The coupler comprises at least two compartments independently openable, each of which allows, in an open position, placement of a wire therein and, in a closed position, retention of the wire therein. The coupler further comprises conductive portions adapted to contact the conductive core. Each compartment comprises at least one of the conductive portions, and at least some of the conductive portions are electrically connected to other conductive portions. The conductive portions may be adapted to penetrate the insulation and contact the conductive core of the wire.

At least two of the conductive portions may be electrically connected to each other and insulated from some of the other conductive portions. In this way, several sets of wires may be coupled with a single coupler, with wires from each set only being electrically connected to other wires within the same set.

The coupler may comprise a base portion and at least two covers. Each cover defines, in conjunction with the base portion, a compartment. Each cover may be hingedly articulated to the base.

Each compartment may be adapted to be opened from the closed position and subsequently re-closed.

The coupler may further comprise a mating arrangement adapted to physically mate two couplers.

The coupler may further comprise an electric device electrically connected to at least one of the conductive portions.

The coupler may further comprise a wire retention channel. The channel is formed from upper and lower channel sections in a mutually closed position associated with the closed position of the compartments. (It should be noted that the terms upper and lower in connection with the channel sections is a convention only, and the channel sections may actually be located side by side, etc.) The channel is associated with a plane which substantially bisects the channel in a longitudinal direction. The upper section comprises a first ridged portion, and the lower section comprises a second ridged portion. The ridged portions are located along the plane, and each has ridges and spaces therebetween. When the channel is in the closed position, the spaces of the first ridged portion are disposed opposite the ridges of the second ridged portion, and the ridges of the first ridged portion are disposed opposite the spaces of the second ridged portion.

According to another aspect of the present invention, there is provided an electrical wire coupler adapted to electrically connect to at least one wire as described above. The coupler comprises a wire retention channel. The channel is formed from upper and lower channel sections in a mutually closed position associated with the closed position of the compartments. The channel is associated with a plane which substantially bisects the channel in a longitudinal direction. The upper section comprises a first ridged portion, and the lower section comprises a second ridged portion. The ridged portions are located along the plane, and each has ridges and spaces therebetween. When the channel is in the closed position, the spaces of the first ridged portion are disposed opposite the ridges of the second ridged portion, and the ridges of the first ridged portion are disposed opposite the spaces of the second ridged portion.

The coupler may further comprise at least two compartments independently openable, each of which allows, in an open position, placement of a wire therein and, in a closed position, retention of the wire therein. The coupler further comprises conductive portions adapted to contact the conductive core. Each compartment comprises at least one of the conductive portions, and at least some of the conductive portions are electrically connected to other conductive portions. The conductive portions may be adapted to penetrate the insulation and contact the conductive core of the wire.

At least two of the conductive portions may be electrically connected to each other and insulated from some of the other conductive portions. In this way, several sets of wires may be coupled with a single coupler, with wires from each set only being electrically connected to other wires within the same set.

The coupler may comprise a base portion and at least two covers. Each cover defines, in conjunction with the base portion, a compartment. Each cover may be hingedly articulated to the base.

Each compartment may be adapted to be opened from the closed position and subsequently re-closed.

The coupler may further comprise a mating arrangement adapted to physically mate two couplers.

The coupler may further comprise an electric device electrically connected to at least one of the conductive portions.

According to a further aspect of the present invention, there is provided an electrical wire coupler adapted to electrically connect at least two wires, the wires each comprising a conductive core and insulation therearound; the coupler allowing, in an open position, placement therein of the wires in a position spaced from each other and, in a closed position, retention therein of the wires; the coupler comprising a connector adapted to contact the conductive cores of the wires to electrically connect the wires, the coupler being adapted to bend each of the wires to assume a serpentine shape at a location spaced from the location of their contact with the connector.

The housing may comprise, at least when in its closed position, separate channels for receiving therein the wires; each of the channels having a contact portion at which the wire is adapted to contact the connector, and a bending portion at which the wire is adapted to assume the serpentine shape.

The housing may further comprise a base and at least one cover articulated thereto by a hinge; the base and cover define therebetween at least one of the channels. The bending portion of each channel is located between the hinge and the contact portion of that channel.

The housing may further comprise at least two covers independently openable, each of the covers forming with the base one of the channels.

The connector may be snappably attachable to the housing.

Each cover may be adapted to be opened from the closed position and subsequently re-closed independently of any other cover.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a perspective view of an embodiment of a coupler according to the present invention;

FIGS. 2A through 2C illustrate a connector of the coupler illustrated in FIG. 1;

FIG. 3A is an enlargement of the area labeled as A is FIG. 1;

FIG. 3B is a side sectional view of a channel of the coupler illustrated in FIG. 1;

FIG. 3C is a side sectional view of a channel of the coupler illustrated in FIG. 1, with a wire held therein;

FIG. 4 is a perspective view of another embodiment of a coupler according to the present invention;

FIG. 5 is a perspective view of a further embodiment of a coupler according to the present invention;

FIGS. 6A and 6B illustrate schematically exemplary uses of the coupler according to any of the above embodiments;

FIG. 7A illustrates a cable having several conductive cores and known locations thereof;

FIG. 7B illustrates a coupler for use with the cable illustrated in FIG. 7A;

FIG. 7C is a top perspective view of the base of the coupler illustrated in FIG. 7B;

FIG. 8A is a top perspective view of a modification of a coupler;

FIG. 8B is a bottom perspective view of a modification of a coupler;

FIG. 8C is a perspective view of several couplers according to the modification illustrated in FIGS. 8A and 8B in use;

FIG. 9 is a perspective view of couplers according to another modification of the present invention;

FIGS. 10A through 10D illustrate several further embodiments of the coupler according the present invention;

FIG. 11 is a cut-away view of the coupler illustrated in FIG. 1 according to a further modification of the present invention;

FIGS. 12A and 12B are front perspective views of a still further embodiment of a coupler according to the present invention, in closed and open positions, respectively;

FIG. 12C is a cross-sectional view of the coupler as illustrated in FIG. 12A, taken along line II-II, with a connector thereof being removed;

FIG. 12D is a side perspective view of the coupler illustrated in FIG. 12B; and

FIG. 13 illustrates a connector of the coupler illustrated in FIGS. 12A and 12B.

### DETAILED DESCRIPTION OF EXEMPLARY EMBODIMENTS

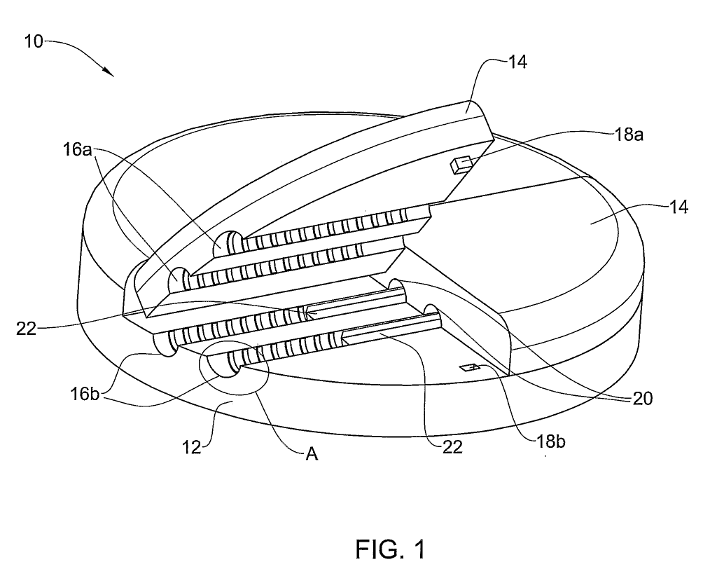

FIG. 1 illustrates one embodiment of a wire coupler, generally designated at 10, in a partially open position. It comprises a base 12 and two covers 14 hingedly attached thereto. In FIG. 1, one cover 14 is shown open, and the other closed. The base 12 and covers 14 are made of an electrically insulating material such as plastic. The base 12 and cover 14 comprise corresponding groove portions 16a and 16b, respectively, and a latch 18a with a corresponding slot 18b. Groove portions 16b which are formed within the base 12 extend the entire width of the base (i.e., under both covers 14), and groove portions 16a formed within the covers are each positioned to match the position of a corresponding groove portion 16b. Each set of corresponding groove portions 16a, 16b form, when the cover 14 is closed, a channel 20 (seen in FIG. 1 only under the cover 14 which is shown in the closed position), which may be in the form of a tube and which is open only at its two ends.

Disposed within each groove portion 16b in the base 12 is a connector 22. Each connector 22 continues extends across the entire width of the groove portion, or at least such that a portion thereof is exposed when each cover 14 is opened.

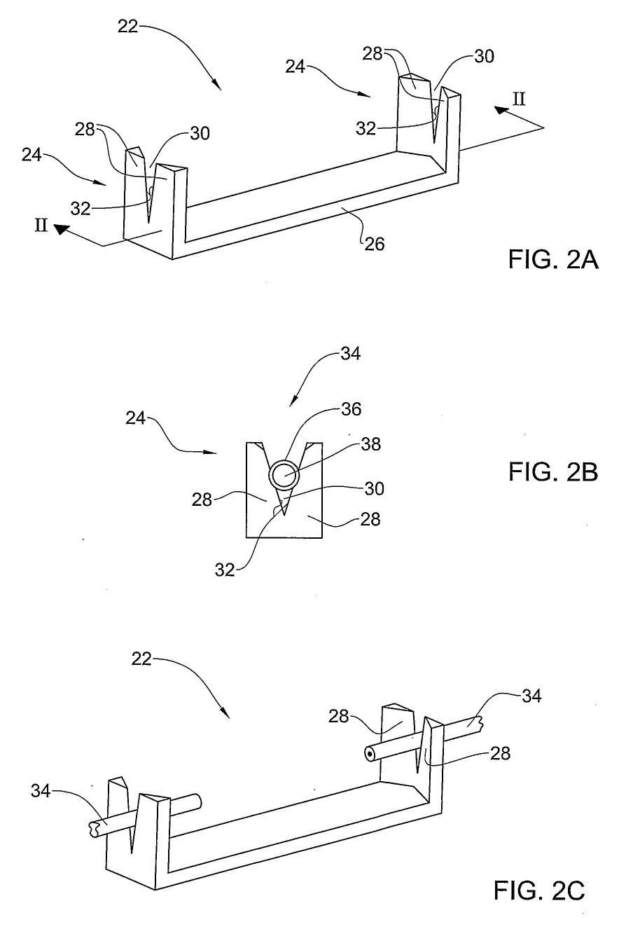

FIGS. 2A and 2B illustrate in more detail a connector 22 for use with the coupler 10 illustrated in FIG. 1. The connector 22 comprises cutting portions, generally indicated at 24, and a bridging portion 26. The entire connector 22 is made from one piece of electrically conductive material, such as copper.

The cutting portion 24 comprises two prongs 28 extending upwardly from the bridging portion 26. The prongs 28 define therebetween a gap 30 which is wide at the top, and narrows toward the bottom. Inwardly facing cutting edges 32 of the prongs 28 are sharp enough to penetrate the insulation of a wire, either by being formed as blades, or by forming the entire prong 28 from a thin piece of metal of generally constant width.

As illustrated in FIG. 2B, when a wire 34 is inserted into the gap 30, the edges 32 of the prongs 28 penetrate the insulation 36 of the wire until contact is made with the conductive inner core 38 thereof. The edges may slightly penetrate the inner core 38 as well, in order to ensure that a good electrical connection is established between the connector 22 and the inner core. As illustrated in FIG. 2C, by inserting two wires 34 into the connector 22, they become electrically coupled.

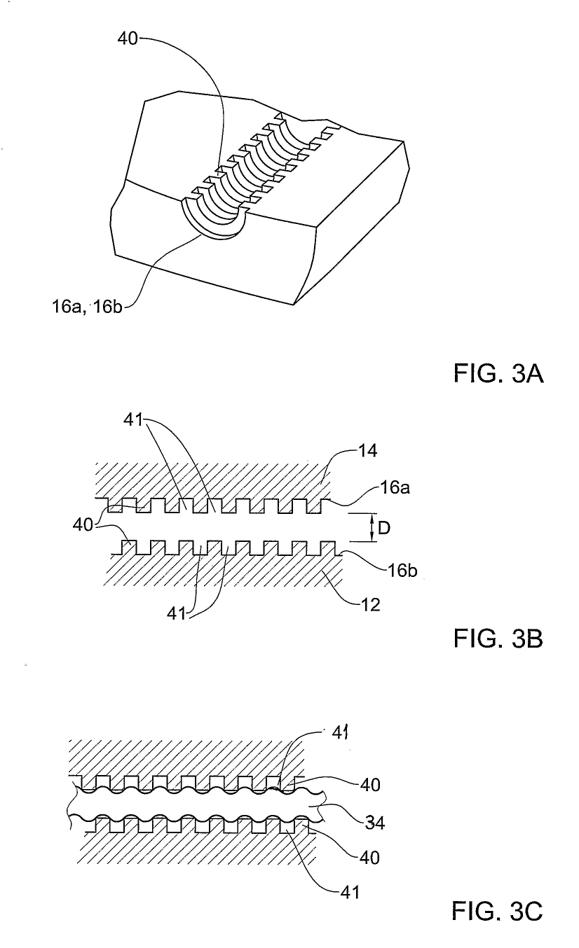

As illustrated in FIG. 3A, each groove portion 16a, 16b comprises ridges 40. As illustrated in FIG. 3B, ridges 40 on the groove portion 16a associated with the cover 14 are disposed so that they are opposite the space 41 between ridges on the groove portion 16b associated with the base 12, at least when the cover is in the closed position. The ridges 40 are sized so that when a the cover 14 is closed with a wire in the groove portions, the distance between the ridges 40, as indicated by D, is slightly smaller than the outer diameter of the wire. As seen in FIG. 3C, when a wire 34 is inserted, the insulation layer is deformed to have an undulating shape. In this way, the ridges 40 cooperate to provide a tight grip on an inserted wire.

In operation, one of the covers 14 is opened. A wire is placed in the gap 30 between the prongs 28 of the cutting portion 24 of the connector 22. The wire may be placed on the prongs without exerting a large force thereon, i.e., one sufficient for the edges 32 to penetrate the insulation of the wire and contact the conductive core. Rather, it only needs to be held in place thereby. The cover 14 is closed, causing the ridges 40 on the groove portion 16a associated therewith to bear upon the wire. This action pushes the wire downward in the gap 30, causing the edges 32 of the prongs 28 to penetrate the insulation of the wire and contact the conductive core. The above-described process is repeated for the other cover, with a second wire being placed in the other cutting portion 24 of the same connector 22. The two wires are thereby electrically connected and secured within the coupler 10.

It is noted that the connectors 22 engage the conductive inner core 38 of the wire 34 without stripping the insulation 36 therefrom. This is advantageous for several reasons. Safety-wise, it is better that the end of a wire is not exposed, since this coupler 10 may be opened while it is connected to an electrically live wire. Furthermore, since the channel 20 may comprise ridges 40 on either side of the cutting portion 24 of the connector 22, by retaining the insulation 36 on the wire 34 on both sides of the location of cutting, the number of ridges which grip the insulation is increased, thereby enhancing the gripping ability of the coupler on the wire. In addition, by cutting the wire perpendicular to the conductive core, and not requiring any movement of the cutting edges 32 along the length of the wire, the coupler 10 is easily adapted to connect wires which have a conductive core that is not solid, but rather comprises a plurality of strands of conductive material, without unraveling the strands.

The coupler 10 illustrated in FIG. 1 comprises two channels 20 when in the closed position. By using the connector 22 described, the wires in each channel 20 are insulated from the wires in the other channel. However, it will be appreciated that the channels may be connected, and a connector 22 may be designed having a bridging potion which rests within the connected channel (e.g., having an X-shape). With such a design, several wires may be electrically connected with a single coupler 10.

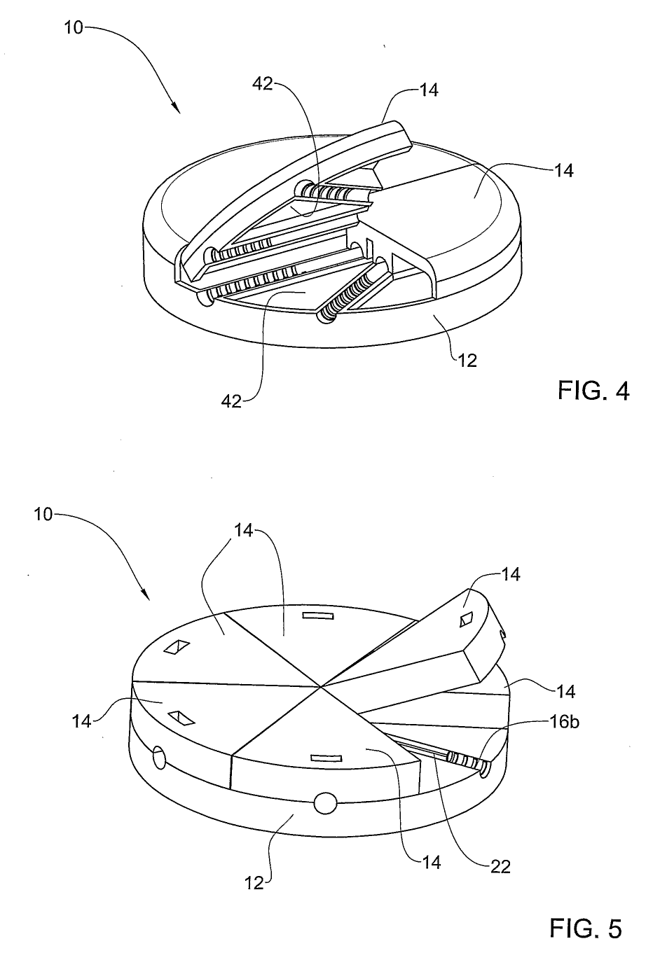

While the groove portions 16a, 16b of the coupler 10 illustrated in FIG. 1 are formed within solid base 12 and covers 14, it will be appreciated that this is not necessary. As illustrated in FIG. 4, the base 12 and covers 14 may form as a shell with a hollow 42 formed therein. The groove portions 16a, 16b are formed as raised channels therein. This allows a connector 22 to be designed having a bridging portion 26 which extends between adjacent channels 20.

As illustrated in FIG. 5, the coupler 10 may be provided with more than two covers 14. The channels may be connected in any desired combination. Indicia 44 may be provided on the exterior surfaces of the covers 14 in order to indicate which channels are connected. The indicia 44 may be etched into the cover, or it may be in the form of a label, such as a color-coded sticker or one having a symbol or letter indication. Alternatively, each cover 14 may be of a different color. Such a coupler 10 would be useful when connecting two cables, each having one ground wire, one neutral wire, and one phase wire.

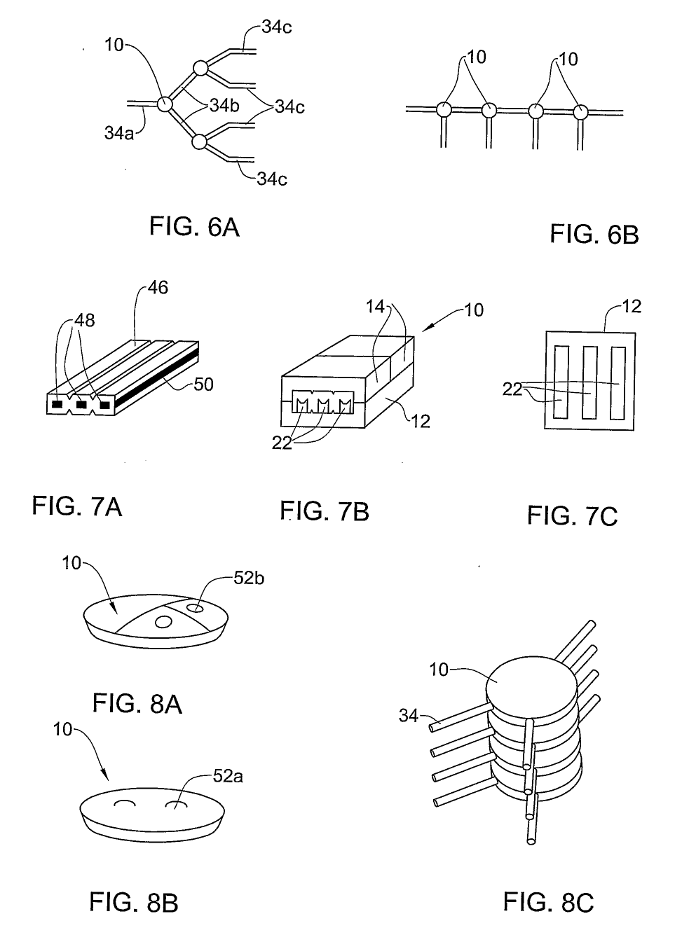

As illustrated schematically in FIG. 6A, a coupler 10 having three channels, all being mutually electrically connected, can be used to split a wire 34a (all wires are indicated by double lines). The wire 34a is connected to a coupler 10 having two. secondary wires 34b attached thereto. Each secondary wire 34b is connected to a coupler 10 which is in turn connected to two tertiary wires 34c, for a total of four available wires. This may be repeated as much as necessary to give any desired number of wires. Alternatively, a bus arrangement may be easily constructed, as illustrated in FIG. 6B.

FIG. 7A through 7C illustrate a special use coupler 10 adapted to connect a cable having several conductive cores in a standard configuration, such as that indicated by 46. The cable 46 comprises several conductive cores 48 arranged in a particular sequence, and a reference stripe 50 along the side of the cable. The reference stripe 50 is used to guide a user, so that when a very long cable is used, it is simple to determine where each conductive core terminates on the other exposed end of the cable. A coupler 10 is provided with a channel 20 having the shape of the profile of the cable 46, and connectors 20 situated so that when the cable is placed therewithin, each connector penetrates the insulation of the cable and contacts one of the conductive cores. As best seen in FIG. 7C, the connectors 20 are not in contact with one another, and extend the length of the base 12, such that they can connect a second cable to the first.

FIGS. 8A and 8B illustrate a modification of the coupler 10, wherein means are provided to stack a plurality thereof. The top and bottom of each coupler 10 may comprise cooperative mating arrangements, such as humps 52a and pits 52b. As seen in FIG. 8C, this allows a plurality of couplers 10 to form a stack, which is useful for extending or splitting wires 34 as described above while at the same time keeping the wires 34 disentangled.

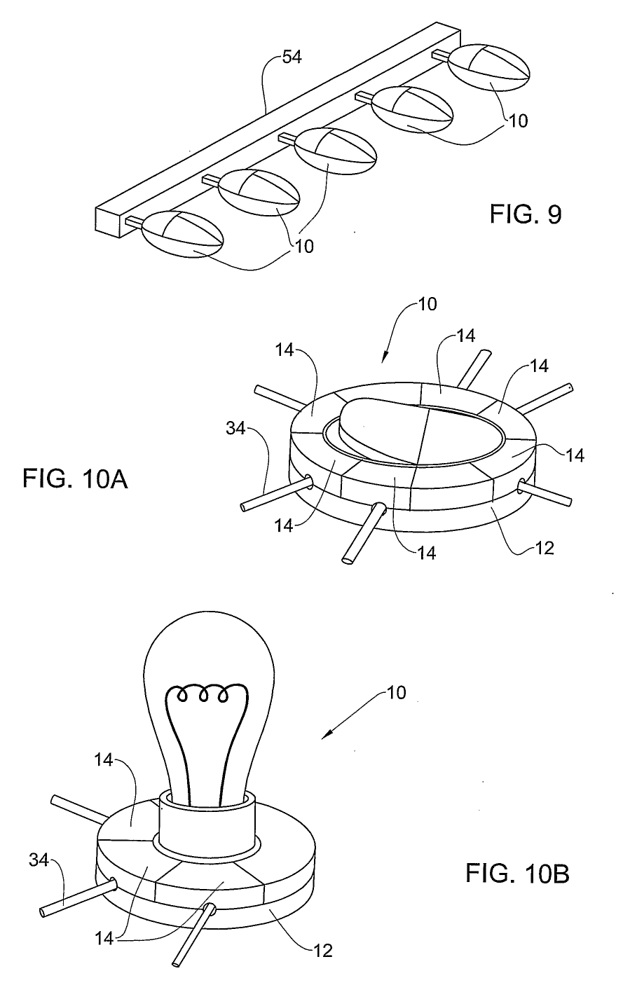

An alternative modification is illustrated in FIG. 9, wherein several couplers 10 may be mutually connected to a single rail 54. The couplers 10 are typically not connected to one another electrically. This arrangement provides many of the same advantages as the modification described with reference to FIGS. 8A and 8B.

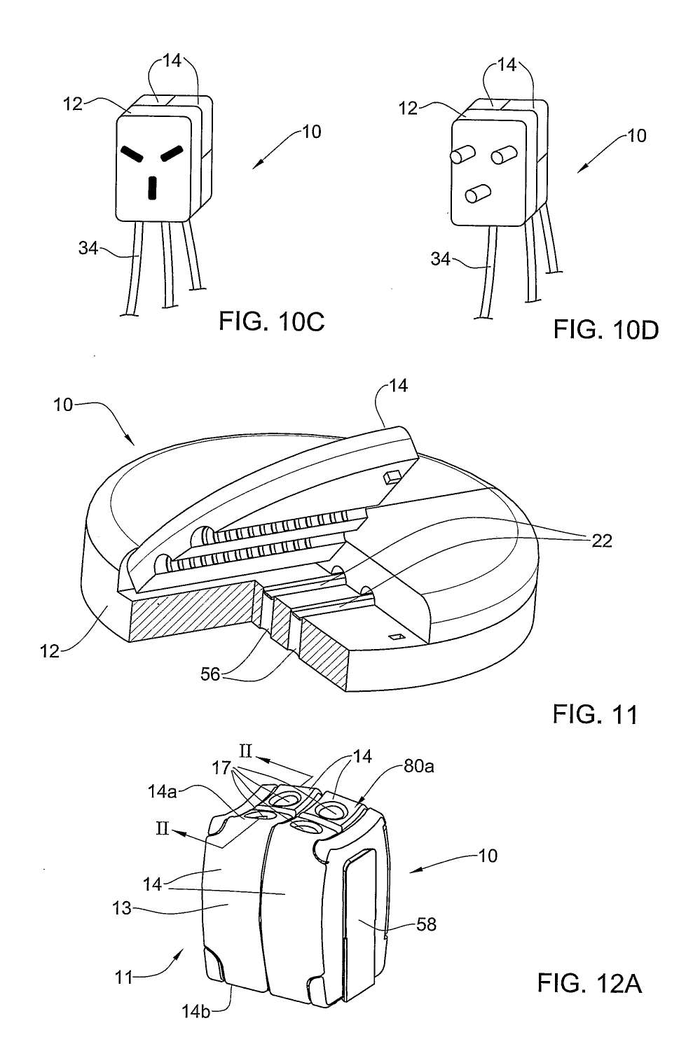

According to further embodiment of the present invention, the coupler 10 may be adapted to connect wires to electric devices, such as switches, light bulbs, outlets, and plugs, as illustrates in FIGS. 10A through 10D. It will be appreciated that although FIGS. 10A through 10D illustrate the respective bases 12 and covers 14 disposed in exemplary positions (e.g., the covers being on top in FIGS. 10A and 10B), in practice, they may be located in any desirable position (i.e., with the covers on the bottom, with the entire bottom constituting a single cover, etc.). While several embodiments are illustrated, it will be appreciated that further embodiments are possible for any device which requires attachment to electrical wires.

According to a further modification of the present invention, as illustrated in FIG. 11, the coupler 10 may be provided with through-going apertures 56. These apertures 56 are sized so as to permit insertion therethrough of probe of an electrical tester (not shown), such as a voltmeter or an ammeter. The apertures 56 may be provided either through the base 12 or the cover 14, and coupler 10 may comprise apertures associated with some or all of the connectors 22.

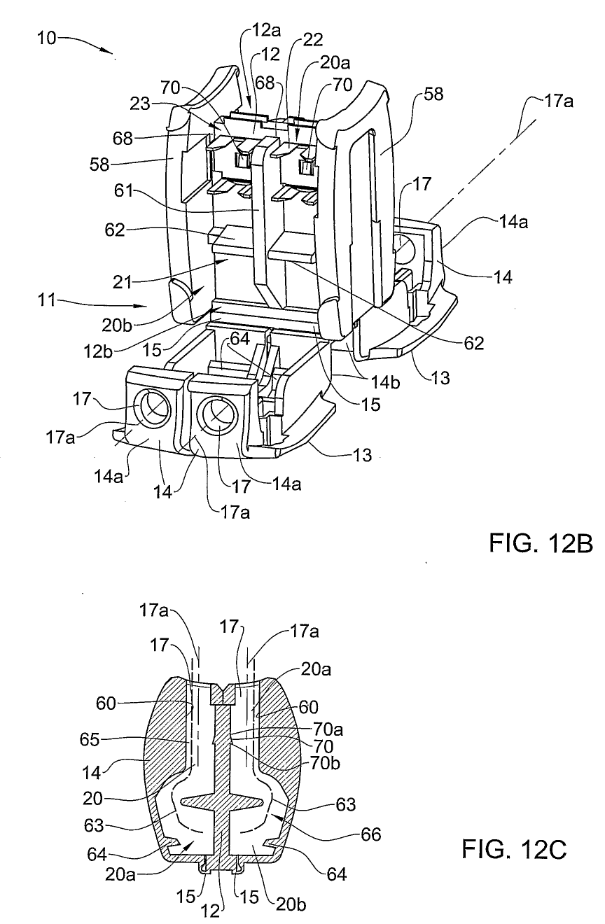

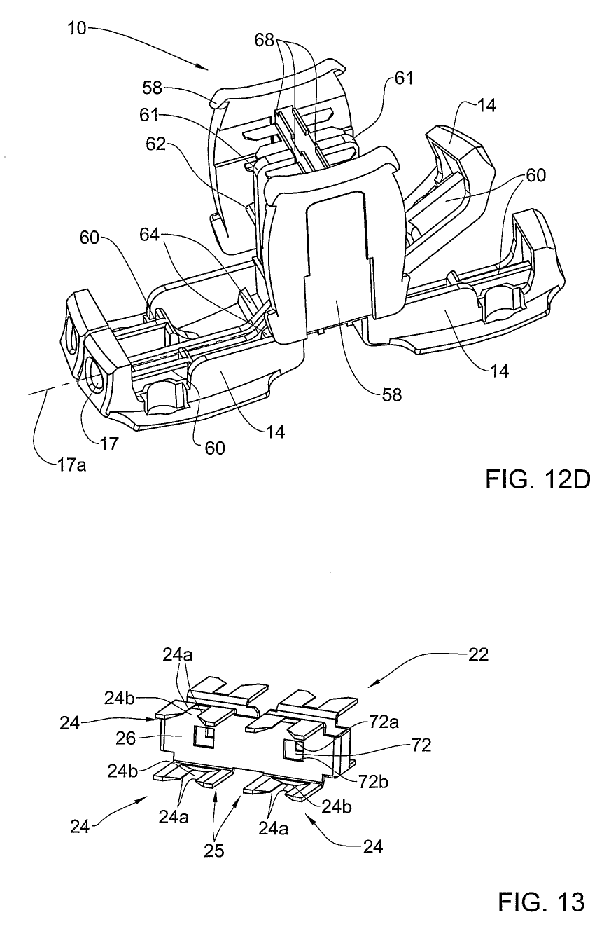

Another example of a coupler 10 according to the present invention is illustrated in FIGS. 12A and 12B, in closed and open positions, respectively. The coupler comprises a non-conductive housing, generally indicated at 11, and a conductive connector 22. The housing 11 is made from an insulating material, such as plastic, and the connector 22 is made from a conductive material, such as copper.

The housing 11 comprises a generally planar base 12 with a proximal end 12a and distal end 12b, four independently moveable covers 14 (see, e.g., in FIG. 12D), each formed as a bracket with an elongated body 13 and proximal and distal legs 14a and 14b oriented transversely to the body 13, and two side walls 58 at the sides of the base. The distal leg 14b of each cover is attached to the base distal end 12b of the base by a hinge 15, which may be a living hinge or any other appropriate means.

The base 12 is formed with two partition walls 61 dividing each side of the base into four wire-receiving areas 21, which form, together with the corresponding cover when closed, a wire-receiving channel 20 extending along an axis 63 between its proximal and distal ends 20a, 20b disposed adjacent to the proximal and distal ends 12a, 12b of the base. The partitions 61 provide electrical insulation between adjacent wires when inserted in the channels 20, and provide additional structural strength to the coupler 10.

The coupler 10 further comprises a connector 22 having four connector portions 25 and the base has a connector-receiving portion 23 at the proximal end 12a thereof, where the connector is mounted so that each connector portion 25 is located at a proximal region of each wire-receiving area 21. The construction of the connector will be described in more detail later.

Each cover 14 is formed with a wire-receiving hole 17, extending along axis 17a, in its proximal leg 14a, which is aligned with the corresponding wire receiving channel 20 when the cover is in its closed position.

As seen in FIGS. 12C and 12D, the base 12 and each cover 14 comprise several features which influence the shape of the channel 20, particularly, allowing it to have a straight portion 65 at the region where the connector portion 25 is disposed, and a serpentine bending portion 66 between the connector portion 25 and the distal end 12b of the base 12. The straight portion 65 of the channel is provided by each cover 14 being formed with a wire stage 60 located and formed such that, when the cover 14 is in its closed position, the wire stage 60 is juxtaposed the connector portion 25, due to which a straight wire which passes through the hole 17 along the axis 17a will extend substantially parallel and adjacent thereto. The serpentine bending portion 66 of each channel 20 is formed by virtue of protrusions in the cover 14 and the wire-receiving area 21 forming the channel, located distally of the connector portion 21. In particular, each wire-receiving area 21 of the base 12 is formed with a first protrusion 62 projecting towards the cover 14, and the cover 14 is formed with a second protrusion 64 projecting towards the base 12. The first protrusion is located closer to the connector portion 25 than the second protrusion 64 is, and the second protrusion is located closer to the distal end 12b of the base 12 than the first protrusion is.

Several features are formed within the connector-supporting area 23 of the housing 11 in order to facilitate insertion and retention of the connector 22. As seen in FIGS. 12B and 12D, gaps 68, adapted to receive the connector, are formed between the base 12 and the partition 61, and between the base and the sidewalls 58. In addition, a wedge-ramp 70, constituting a connector-retaining means, projects from the connector supporting area 23. As seen in FIG. 12C, each wedge-ramp comprises a proximal edge 70a, which is level with the base 12, and a distal edge 70b, which extends substantially perpendicularly from the base to the surface of the wedge-ramp. The purpose of these features will become clear below.

As seen in FIG. 13, the connector 22 is formed generally as a rectangular loop, and comprises the cutting portions 24 and a bridging portion 26. Each cutting portion 24 comprises a pair of blades 24a whose razor edges face one another, with a gap 24b therebetween. The gap 24b is sized such that it is somewhat smaller than the conductive core of the wire. Square or rectangular shaped apertures 72, each sized slightly larger than the wedge-ramps 70, are formed within the bridging portion 26 thereof. Each aperture comprises a proximal edge 72a and a distal edge 72b.

When the connector 22 is inserted onto the base 12 at the connector-supporting portion 23 thereof, it is slid within the gaps 68. Since the proximal edge 70a of the wedge-ramp 70 is level with the base, the connector 22 easily slides over it, by bending slightly away from the base 12, within the elastic range of the material of the connector 22. When the distal edge 72b of the aperture 72 clears passes the distal edge 70b of the wedge-ramp 70, the connector 22 returns to its rest state, and the wedge-ramp is thus received within the aperture. The connector is thus snappably attached to the connector supporting portion 23 of the base 12. If the connector is subsequently urged proximally, the distal edge 72b of the aperture 72 bears against the distal edge 70b of the wedge-ramp 70, which prevents this movement. The connector 22 is thus retained on the connector-supporting portion 23 of the base.

During use, a wire is inserted through the opening 17 of one of the covers 14, ideally until it passes the second protrusion 64, when the cover 14 is in its open position. The cover is then closed, which brings the connector portion 25 into contact with the wire at the straight portion 65 of the channel 20. The cutting portions 24 of the connector portion 25 penetrate the insulation of the wire and contact the conductive core thereof In this way, all wires which contact a single connector 22 are electrically connected to one another.

The serpentine bending portion 66 of the channel 20 bends the wire imparting thereto a serpentine shape when retained therein, which tightly holds the wire in place. The location of the wire stage 60 ensures that the wire must bend to circumvent the first protrusion 62. The second protrusion 64 ensures that the wire must bend distally of the first protrusion 68, which completes the serpentine shape of the wire.

It will be appreciated that since the serpentine bending portion 66 of the channel 20 is located distally from the connector portion 25, i.e., it is closer than the connector portion 25 to the hinge 15, when the cover 14 is closed, the wire is bent into the serpentine shape before it is fully penetrated by the connector 22. In this way, axial displacement due to bending of the wire is reduced once penetration by the blades 24a of the connector 22 is completed, which lowers the deformation of the wire at the point of contact by the connector.

Those skilled in the art to which this invention pertains will readily appreciate that numerous changes, variations and modifications can be made without departing from the scope of the invention mutatis mutandis.

1-16. (canceled)

17. An electrical wire coupler adapted to electrically connect at least two wires, the wires each comprising a conductive core and insulation therearound; the coupler comprising at least two compartments independently openable, each of said compartments allowing, in an open position, placement therein of at least one wire and, in a closed position, retention therein of the at least one wire; the coupler further comprising conductive portions adapted to contact the conductive core, wherein each compartment comprises at least one conductive portion, and said at least one conductive portion being electrically connected to at least one other portion of at least one other compartment.

18. A coupler according to claim 17, wherein said conductive portions are adapted to penetrate the insulation and contact the conductive core of the wire.

19. A coupler, according to claim 17, wherein at least two of said conductive portions are electrically connected to each other and insulated from some of the other portions.

20. A coupler according to claim 17, further comprising a base portion and at least two covers, each cover defining with the base portion a compartment.

21. A coupler according to claim 20, wherein each cover is hingedly articulated to the base.

22. A coupler according to claim 17, further comprising a wire retention channel being formed from upper and lower channel sections in a mutually closed position associated with the closed position of the compartments, said channel being associated with a plane which substantially bisects the channel in a longitudinal direction, the upper section comprising a first ridged portion, and the lower section comprising a second ridged portion, said ridged portions being located along the plane, the ridged portions each having ridges and spaces therebetween wherein when the channel is in the closed position, the spaces of the first ridged portion are disposed opposite the ridges of the second ridged portion, and the ridges of the first ridged portion are disposed opposite the spaces of the second ridged portion.

23. A coupler according to claim 17, wherein each compartment is adapted to be opened from the closed position and subsequently re-closed.

24. A couplet according to claim 17, further comprising a mating arrangement adapted to physically mate two couplers.

25. A coupler according to claim 17, further comprising an electric device electrically connected to at least one of the conductive portions.

26. A coupler according to claim 17, being adapted to bend each of said wires to assume a serpentine shape.

27. A coupler according to claim 17, wherein each of said compartments allows, in an open position, placement therein of a single wire and, in a closed position, retention therein of said single wire.

28. An electrical wire coupler adapted to electrically connect at least two wires, the wires each comprising a conductive core and insulation therearound; the coupler allowing, in an open position, placement therein of the wires in a position spaced from each other and, in a closed position, retention therein of the wires; the coupler comprising a base and at least one cover articulated thereto by a hinge, said base and each of said at least one cover defining therebetween a channel, the coupler further comprising a connector adapted to contact the conductive cores of the wires to electrically connect the wires, each channel having a contact portion at which the wire is adapted to contact said connector and a bending portion adapted to bend each of said wires to assume a serpentine shape, said bending portion being located between the hinge and the contact portion of the channel.

29. A coupler according to claim 28, wherein said housing comprises at least two covers independently openable, each of said covers forming with said base one of said channels.

30. A coupler according to claim 28, wherein the connector is snappably attachable to the housing.

31. A coupler according to claim 30, wherein each cover is adapted to be opened from the closed position and subsequently re-closed independently of any other cover.
